(19) United States
(12) Patent Application Publication
(10) Pub. No.: US 2010/0029194 A1
(43) Pub. Date: Feb. 4, 2010

(54) AIR OUTLET AND A METHOD FOR ITS MANUFACTURE

(76) Inventor: Eckehard Fiedler, Aachen (DE)

Correspondence Address: COLLARD & ROE, P.C., 1077 NORTHERN BOULEVARD, ROSLYN, NY, 11576, US

(21) Appl. No.: 12/449,498

(22) PCT Filed: Feb. 13, 2008
(86) PCT No.: PCT/EP2008/001086

§ 371 Date: Aug. 11, 2009

(30) Foreign Application Priority Data
Feb. 15, 2007 (DE) 10 2007 008 019.2

(51) Int. Cl. F24F 13/068; B23P 11/00

(52) U.S. Cl. 454/296; 29/428

(57) ABSTRACT

The invention relates to an air outlet (1, 1′), comprising a connecting piece (2) for the at least indirect connection to an air supply system, a housing (4) delimiting an air distribution chamber (7), and a perforated plate (5) forming an effective air discharge cross-section (10) of the air outlet (1, 1′), wherein a center line (9) of the connecting piece (2) is oriented perpendicular to the perforated plate (5). Starting from a center region of the housing (4), in which the connecting piece (2) empties into the air distribution chamber (7), walls (11) of the housing (4) that face the perforated plate (5) wrap around and extend in the direction of the perforated plate (5), inclined at an acute angle α in relation to the perforated plate (5). The invention further relates to a suspended ceiling or a wall paneling, and to a method for producing a previously described air outlet (1, 1′). In order to refine the air outlet known from the state of the art regarding the flow behavior of the escaping air, and in order to improve the optical properties and provide a simplified method for producing an air outlet, according to the invention the perforated plate (5) is a panel (6) of a louvered ceiling or a wall paneling.

### INTRODUCTION

The invention relates to an air outlet with a connecting stub pipe for at least indirect connection to an air supply system, a housing that bounds an air distribution chamber, and a perforated plate that forms an effective air discharge cross-sectional area of the air outlet, wherein a central axis of the connecting stub pipe is oriented at right-angles to the perforated plate, wherein starting from a central region of the housing in which the connecting stub pipe opens out into the air distribution chamber, walls of the housing facing towards the perforated plate extend circumferentially in the direction of the perforated plate, and inclined at an acute angle α relative to the perforated plate. The invention further relates to a suspended ceiling or wall cladding, and to a method for the manufacture of the previously described air outlet.

### BACKGROUND OF THE INVENTION

The air outlets of known art from the prior art are typically furnished with guidance devices, such as, for example, blades or guide vanes, to achieve turbulent mixing. The disadvantage of these air outlets is, however, that if the air outlets are used for a longer period of time the guidance devices leave visible dirt tracks behind them.

In order to counter this disadvantage the walls facing towards the perforated plate in the ceiling air outlet according to DE 20 2006 007 846 U1 are arranged at an acute angle α between 3° and 25° to the ceiling plane. In this arrangement of the walls turbulent mixing with a high induction effect can be achieved with an appropriate air supply, without the need for further guidance devices to be fitted—apart from the walls of the housing, the connecting stub pipe and the perforated plate.

A further disadvantage of the air outlets of known art from the prior art lies in their visual appearance. The fitting of the air outlets of known art takes place either in recesses fitted in the ceiling or wall, or in a ceiling or wall panel—wherein the air outlets per se must be manufactured so as to correspond to the dimensions of the recess—or in yet to be individually produced cut-outs in the suspended ceiling or wall cladding, or in a ceiling or wall panel—wherein the recesses must be matched to the dimensions of the air outlets. Neither installation variant necessarily offers flexible fitting of the units.

Since the perforated plates of the air outlet and of the suspended ceiling or wall cladding seldom coincide with regard to hole pattern, colours and other structures, the air outlets always remain visible in the structure from the interior of the room. Also any defects arising as a result of faulty fitting of the air outlets are thus visible and require rectification. As a rule any cladding of the perforated plate of the air outlet is not possible, since the desired ventilation effect would thereby be severely restricted.

### OBJECT

The object of the present invention is to develop further the air outlet of known art from the prior art such that the flow characteristics of the discharging air are further optimised. Furthermore the installation of the air outlet should prove to be flexible and improved with regard to its visual properties. Moreover a simplified method for the manufacture of an air outlet should be provided.

### SOLUTION

Starting from an outlet of the kind described in the introduction this object is achieved in that the perforated plate is a panel of a grid ceiling or wall cladding.

Accordingly the air outlet before its fitting in or on a panel is not yet equipped with a perforated plate as is of known art from the prior art, but in the first instance simply comprises a housing with a connecting stub pipe and an open discharge cross-sectional area for the air. Only after the housing is fitted onto the perforated plate of a panel is the outlet complete and able to exercise its function. Since the housing meets up with the perforated plate “from above” or “from the exterior”, it is not visible from the interior of the room and the appearance of the suspended ceiling or wall cladding is not interrupted at any point.

In addition to the visual advantages that ensue from the outlet according to the invention, a flexible and rapid installation of the same is furthermore possible. On the one hand the fitting is not dependent on predefined recesses and on the other hand the attachment of the outlet to the panel can be implemented very easily and conveniently. Furthermore the outlet according to the invention is distinguished by the fact that its position on the panel can be altered simply and flexibly, insofar as any lines and connections offer sufficient freedom.

Finally the outlet according to the invention provides the advantage that the latter is independent of recesses in the panel, so that it is possible to work with units of standard sizes, a fact that ultimately can also bring with it not inconsiderable cost savings.

It has been shown that the hole size of the perforated plate is immaterial within wide limits for the functionality of the outlet, for which reason the device according to the invention can find application independently of the design of the ceiling or wall panels. The necessary induction effect can be regulated by means of an appropriate air supply, such that the discharge of the air always occurs approximately parallel to the plane formed by the perforated plate and a pleasant interior environment is created.

Advantageously the panel projects beyond the edges of the housing of the air outlet. In this manner the location of the air outlet does not have to be aligned with any edges, a fact that again simplifies installation considerably. The discharge cross-sectional area of the housing and the ceiling panel need not be matched to one another with regard to their sizes. It is also possible for the discharge cross-sectional area of the housing to extend over regions of a plurality of adjacent panels.

One embodiment of the device according to the invention envisages that the housing of the air outlet is connected to the panel such that it is invisible from the room to be ventilated, in particular, is attached to the panel with adhesive. In contrast to connection by means of screws, rivets or other mechanical means in connection, in which at least the heads, nuts or similar can be detected, the former type of connection is completely invisible from the interior of the room.

Furthermore it is particularly of advantage if a transition piece is arranged between the housing and the connecting stub pipe, the cross-sectional area of the transition piece at right-angles to the flow direction being larger than the cross-sectional area of the connecting stub pipe, wherein the transition from the connecting stub pipe to the transition piece has a sudden alteration of cross-sectional area. The sudden expansion from the connecting stub pipe to the transition piece promotes on the one hand the induction effect and on the other hand promotes the flow pattern of the air in such a manner that optimal mixing and an optimal direction of discharge of the air from the air outlet are achieved. Immediately upon leaving the connecting stub pipe the discharging air is turned into an approximately horizontal direction such that when flowing through the housing it stays close to its inclined walls and after passing through the perforated plate leaves the air outlet approximately parallel to the panels. In this manner pleasant ventilation of a room is created.

For both the manufacture of the air outlet per se, and also the above-mentioned favourable airflow it is of advantage if the shape of the housing is that of a truncated pyramid or a truncated cone and the shape of the transition piece is that of a cuboid or a cylinder, wherein the central axis of the cylinder thus formed runs parallel to the flow direction.

If the ratio of the cross-sectional area of the transition piece to that of the connecting stub pipe lies between 1.0 and 1.5, and the ratio of the cross-sectional area of the transition piece to the maximum cross-sectional area of the housing lies between 0.4 and 0.6, and the ratio of the height of the transition piece to the edge length or diameter of the transition piece lies between 0.1 and 0.2, then the advantages cited above are particularly well achieved. The optimum choices for the ratios cited above are 1.3 and 0.5 and 0.15.

The air outlet is advantageously furnished with an enclosure that is flush with the lower edge of the housing, which enclosure surrounds the housing, the transition piece, the connecting stub pipe and an open space located above these, and furthermore is fitted with a connecting piece. In this manner the opportunity is, for example, provided to create a so-called indirect connection between the connecting stub pipe and an air supply system, wherein the connecting stub pipe does not have to be connected directly with an air supply system. Instead the air supply passage can open out into the housing without being connected to the connecting stub pipe. The connecting stub pipe can be designed in the shape of an intake nozzle.

One advantageous form of embodiment of the air outlet according to the invention furthermore envisages that the open space is subdivided by a filter into an untreated air chamber and a clean air chamber. In this manner the air outlet is also suitable for use in clean room facilities.

A further solution of the task of the present invention is a suspended ceiling or wall cladding with panels designed as perforated plates, characterised in that a region of the ceiling or wall forms an air discharge cross-sectional area of an air outlet covering at least one panel from above or from the exterior in accordance with one of the previous claims.

Furthermore the object of the invention is solved by a method for the manufacture of an air outlet, consisting of an air connecting stub pipe to connect with an air supply system, a housing that bounds an air distribution chamber, and a perforated plate that forms the air discharge cross-sectional area of the air outlet, in which a panel of a grid ceiling or wall cladding is used as a perforated plate. In this manner the advantages cited for the device are particularly simply achieved.

Here the air outlet is advantageously manufactured only at the moment of installation into an intermediate ceiling or wall space by connecting the housing with the panel.

The method of manufacture is further embodied in that the air outlet with a circumferential edge of a housing, which edge runs within a plane, is brought into planar contact with the panel, and thereby is circumferentially sealed at its edge.

### EXAMPLE OF EMBODIMENT

In what follows the invention is elucidated in more detail with the aid of two examples of embodiment of air outlets according to the invention, which are represented in the drawings.

In the figures:

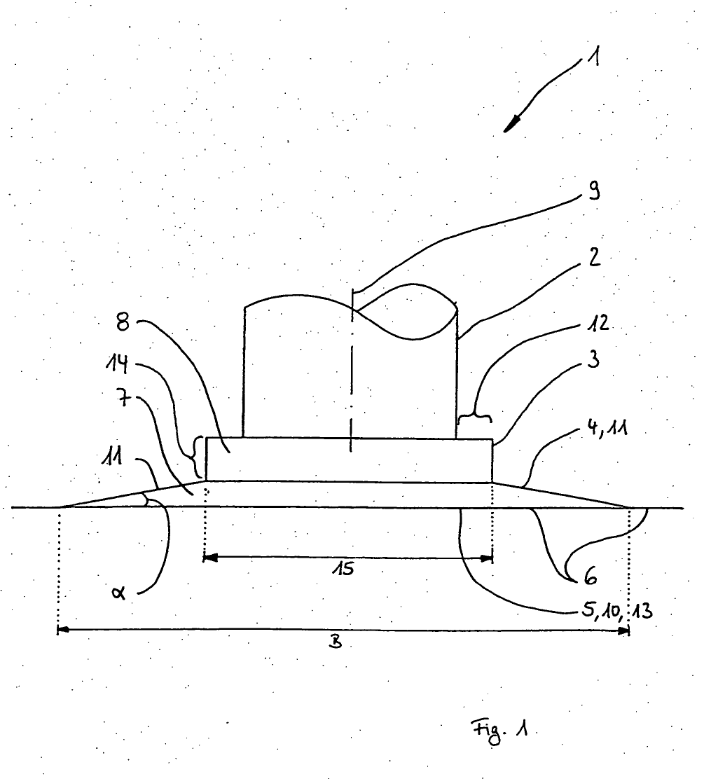

FIG. 1: shows a vertical section through a first example of embodiment of an air outlet according to the invention,

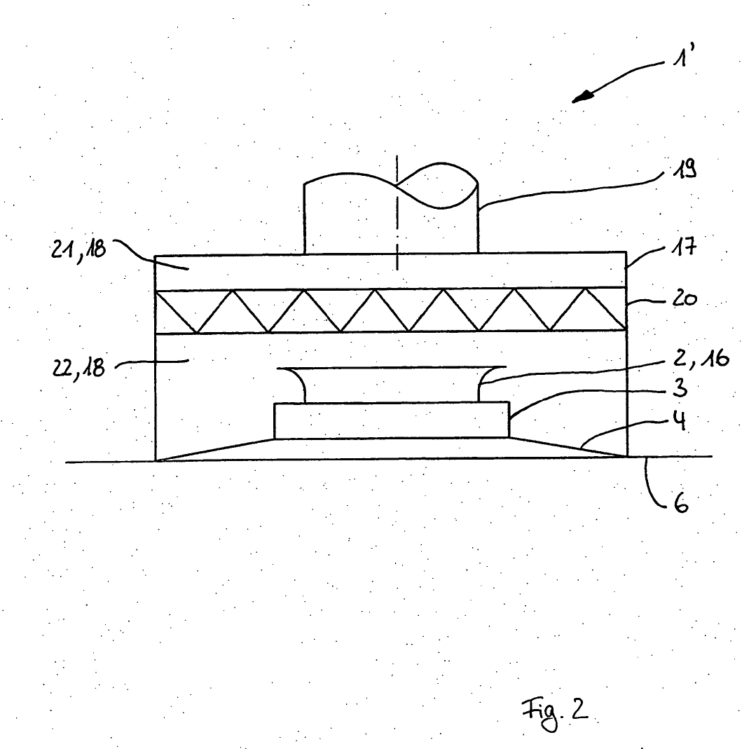

FIG. 2: shows a vertical section through a second example of embodiment of an air outlet according to the invention,

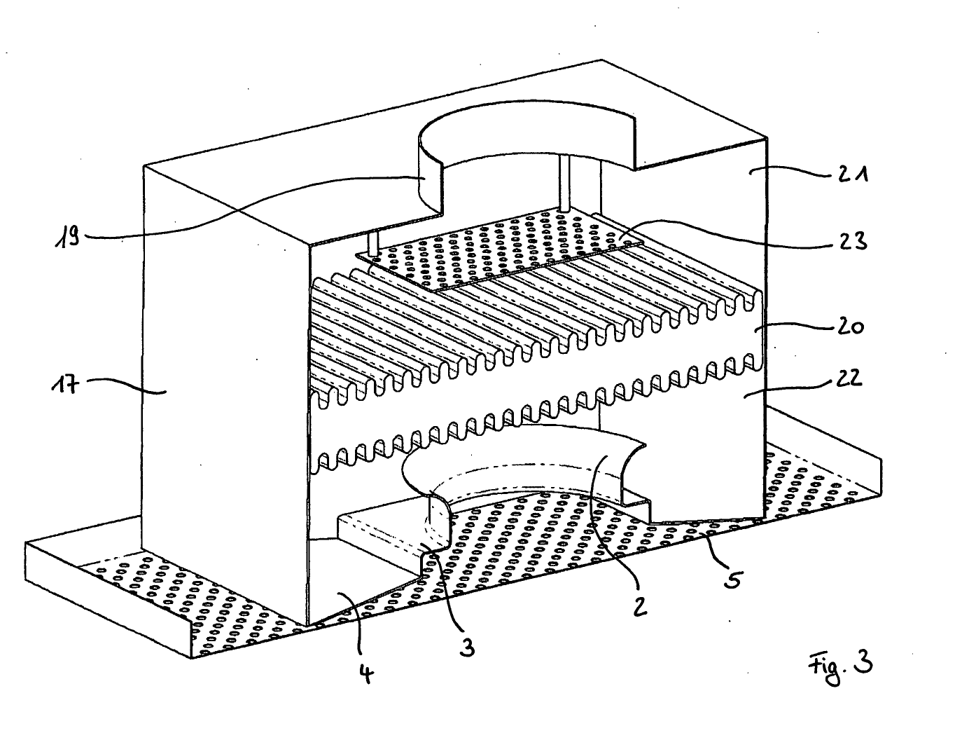

FIG. 3: shows a perspective representation of the air outlet according to FIG. 2.

In the vertical section through a first example of embodiment of an air outlet 1 according to the invention represented in FIG. 1, in particular of a ceiling air outlet, the essential components according to the invention can be discerned. The air outlet 1 is equipped with a connecting stub pipe 2 for purposes of at least indirect connection with an air supply system, not represented. The connecting stub pipe 2 is connected firstly to a transition piece 3, and then to a housing 4, which in turn is placed in position on a ceiling panel 6 embodied as a perforated plate 5. An air distribution chamber 7 is bounded by the ceiling panel 6 and the housing 4, wherein the chamber 8 within the transition piece 3 can also be attributed to the former chamber. The central axis 9 of the connecting stub pipe 2 stands at right-angles to the ceiling panel 6.

At first, that is to say, before the start of fitting, just the connecting stub pipe 2, the transition piece 3 and the housing 4 form a unit, which per se is not yet functional and possesses a completely open discharge cross-sectional area for the air. Only after this unit is placed in position on the ceiling panel 6 is the air outlet 1 equipped with a perforated plate 5 defining the effective air discharge cross-sectional area 10 and after connection to the air supply system can be brought into operation. Here the width of the ceiling panel 6 is greater than the width B of the housing 4. Accordingly the ceiling panel 6 in the region underneath the housing 4 can be regarded as an integrated component of the air outlet 1. The attachment of the housing 4 to the ceiling panel 6 can take place using screws or other means. If high visual requirements are placed on the ceiling of the room as seen from the interior of the room, it is, however, advantageous if attachment takes place by means of the application of adhesive, wherein in all cases the connection onto the upper face of the ceiling panel 6 should be as tightly sealed as possible in order to prevent any lateral leakage of air into the intermediate ceiling space.

From a technical point of view there are no particular requirements on the positioning of the air outlet 1, since the extent to which the ceiling panel 6 projects beyond the edges of the housing 4 is immaterial. Furthermore the air outlet 1 according to the invention is also ready for use even if the whole of the area of the housing 4 projected onto the suspended ceiling does not consist of a perforated plate 5. While it is true that the air discharge cross-sectional area 10 is then reduced and a horizontal discharge flow is not provided in all directions, nevertheless this does not limit the usability of the air outlet 1 to a significant extent and can on occasion also be desirable. For this case the air supply must simply be regulated.

The application of the air outlet 1 according to the invention is distinguished by a high level of flexibility with regard to its positioning, and also a very low level of fitting effort. On the one hand an air outlet 1 can be called upon to ventilate just a single room, on the other hand, however, it can theoretically also be used to ventilate rooms that are adjacent to one another, wherein the air outlet 1 needs only to be positioned such that an air discharge cross-sectional area 10 is present in both rooms.

The walls 11 of the housing 4 are inclined at an acute angle α relative to the ceiling panel 6, which angle preferably lies between 9® and 11°. A discharge of air in an approximately horizontal direction is achieved by this means. Furthermore the transition piece 3, whose cross-sectional area at right-angles to the flow direction is greater than the cross-sectional area of the connecting stub pipe 2, such that a sudden expansion 12 of cross-sectional area occurs in the direction of flow, acts favourably on the induction effect and the flow pattern of the air. The direction of discharge of the air from the air outlet 1 is optimised by means of the arrangement of the transition piece 3, since immediately upon leaving the connecting stub pipe 2 the discharging air is deflected into an approximately horizontal direction by means of the sudden expansion 12 of the cross-sectional area, and then when flowing through the housing 4 stays close to its walls 11. The air leaves the air outlet 1 in a direction approximately parallel to the ceiling panels 6, as a result of which good ventilation of the room is achieved.

The geometry of the air outlet 1 plays a large role in the flow pattern of the discharging air. In the air outlet 1 represented in FIG. 1 the transition piece 3 is designed either as a cuboid or as a cylinder, wherein depending on this choice the housing 4 is constructed as a truncated pyramid or a truncated cone. The ratio of the cross-sectional area of the transition piece 3 to the cross-sectional area of the connecting stub pipe 2 is 1.3, the ratio of the cross-sectional area of the transition piece 3 to the maximum cross-sectional area of the housing 4, i.e. the lower face 13 of the housing 4, is 0.5, and the ratio of the height 14 of the transition piece 3 to the edge length 15 or diameter of the transition piece 3 is 0.15. With these ratios optimal flow conditions exist for the air discharging from the air outlet 1.

FIG. 2 shows a vertical section through a second example of embodiment of an air outlet 1′ according to the invention, which is also designed as a ceiling air outlet. In an analogous manner to the example of embodiment in FIG. 1 the air outlet 1′ possesses a connecting stub pipe 2′, a transition piece 3 and a housing 4. The connecting stub pipe 2′ is designed as an intake nozzle 16. Furthermore the air outlet 1′ is furnished with an enclosure 17, which on the one hand surrounds the connecting stub pipe 2′, the transition piece 3, the housing 4, and furthermore an open space 18 located above the connecting stub pipe 2′. The lower edge of the enclosure 17 connects flush with the lower edge of the housing 4, wherein the enclosure 17 and the housing 4 either separately in each case, or jointly as a unit, are placed in position on a ceiling panel 6 and fixed in place. Furthermore the enclosure 17 is fitted with a connecting piece 19 to connect with an air supply system, not represented, wherein the connecting stub pipe 2′ and the connecting piece 19 are not directly connected with one another.

A filter 20 is arranged in the open space 18 of the enclosure 17, which filter subdivides the open space 18 into an untreated air chamber 21 and a clean air chamber 22. This arrangement is accordingly suitable for use in clean air facilities.

Finally FIG. 3 shows a perspective representation of the air outlet 1′ according to FIG. 2. It can be seen that the housing 4 is designed as a truncated pyramid and the transition piece 3 as a cuboid. The air outlet 1′ is positioned on the ceiling panel 6 such that the air discharge cross-sectional area 10 of the perforated plate 5 of the ceiling panel 6 forming the air outlet 1′ projects beyond the base area of the air outlet 1′. The filter 20 subdividing the open space 18 within the enclosure 17 into an untreated air chamber 21 and a clean air chamber 22 is advantageously a HEPA (High Efficiency Particulate Air) filter. Furthermore it can be seen in FIG. 3 that a perforated plate 23 is arranged beneath the connecting piece 19 to even out the air flow within the untreated air chamber and through the filter 20.

### REFERENCE SYMBOL LIST

1 Air outlet
1′ Air outlet
2 Connecting stub pipe
2′ Connecting stub pipe
3 Transition piece
4 Housing
5 Perforated plate
6 Ceiling panel
7 Air distribution chamber
8 Chamber
9 Central axis
10 Air discharge cross-sectional areas
11 Walls
12 Sudden expansion
13 Lower face
14 Height
15 Edge length
16 Intake nozzle
17 Enclosure
18 Open space
19 Connecting piece
20 Filter
21 Untreated air chamber
22 Clean air chamber
23 Perforated plate
α Angle
B Width

1. An air outlet (1, 1′), with a connecting stub pipe (2) for at least indirect connection to an air supply system, a housing (4) that bounds an air distribution chamber (7), and a perforated plate (5) that forms an effective air discharge cross-sectional area (10) of the air outlet (1, 1), wherein
a central axis (9) of the connecting stub pipe (2) is oriented at right-angles to the perforated plate (5), wherein
starting from a central region of the housing (4), in which the connecting stub pipe (2) opens out into the air distribution chamber (7), walls (11) of the housing (4) facing towards the perforated plate (5), extend circumferentially in the direction of the perforated plate (5), and inclined at an acute angle α relative to the perforated plate (5),
that wherein the perforated plate (5) is a panel (6) of a grid ceiling or wall cladding.

2. The air outlet (1, 1′) according to claim 1,
wherein the panel (6) projects beyond the edges of the housing (4) of the air outlet (1, 1′).

3. The air outlet (1, 1′) according to claim 1,
wherein the housing (4) of the air outlet (1, 1′) is connected, in particular is attached with adhesive, to the panel (6) in a manner that is invisible from the room to be ventilated.

4. The air outlet (1, 1′) according to
claim 1, wherein a transition piece (3) is arranged between the housing (4) and the connecting stub pipe (2), the cross-sectional area of the transition piece at right-angles to the flow direction being larger than the cross-sectional area of the connecting stub pipe (2), wherein
the transition from the connecting stub pipe (2) to the transition piece (3) has a sudden alteration of cross-sectional area.

5. The air outlet (1, 1′) according to claim 4,
wherein the shape of the housing (4) is that of a truncated pyramid or a truncated cone and the shape of the transition piece (3) is that of a cuboid or cylinder, wherein
the central axis (9) of the cylinder thus formed runs parallel to the flow direction.

6. The air outlet (1, 1′) according to claim 4,
wherein the ratio of the cross-sectional area of the transition piece (3) to that of the connecting stub pipe (2) lies between 1.0 and 1.5, and in particular is 1.3, the ratio of the cross-sectional area of the transition piece (3) to the maximum cross-sectional area of the housing (4) lies between 0.4 and 0.6, and in particular is 0.5, and the ratio of the height (14) of the transition piece (3) to the edge length (15), or diameter of the transition piece (3), lies between 0.1 and 0.2 and in particular is 0.15.

7. The air outlet (1, 1′) according to,
claim 1, wherein the housing (4) of the air outlet (1, 1′) is furnished with an enclosure (17) that is flush with the lower edge of the housing (4), which enclosure surrounds the housing (4), the transition piece (3), the connecting stub pipe (2) and an open space (18) located above these, and furthermore is fitted with a connecting piece (19).

8. The air outlet (1, 1′) according to claim 7,
wherein the open space (18) is subdivided by a filter (20) into an untreated air chamber (21) and a clean air chamber (22).

9. A suspended ceiling or wall cladding with panels (6) designed as perforated plates (5),
wherein a region of the ceiling or wall forms an air discharge cross-sectional area (10) of an air outlet (1, 1′) covering at least one panel (6) from above or from the exterior in accordance with claim 1.

10. A method for the manufacture of an air outlet (1, 1′), consisting of a connecting stub pipe (2) to connect with an air supply system, a housing (4) that bounds an air distribution chamber (7), and a perforated plate (5) that forms an effective air discharge cross-sectional area (10) of the air outlet (1, 1′),
wherein a panel (6) of a grid ceiling or wall cladding is used as the perforated plate (5).

11. The method according to claim 10,
wherein the air outlet (1, 1′) is manufactured only at the moment of installation into an intermediate ceiling or wall space by connecting the housing (4) with the panel (6).

12. The method according to claim 10,
wherein the air outlet (1, 1′) with a circumferential edge of a housing (4), which edge runs within a plane, is brought into planar contact with the panel (6) and thereby is circumferentially sealed at its edge.
